(19) United States
(12) Patent Application Publication
(10) Pub. No.: US 2025/0133977 A1
(43) Pub. Date: May 1, 2025

(54) AGRICULTURAL IMPLEMENT POSITION SENSOR AND RELATED DEVICES, SYSTEMS, AND METHODS

(71) Applicant: Ag Leader Technology, Ames, IA (US)

(72) Inventors: Alan F. Barry, Nevada, IA (US); Owen Laumbach, Ames, IA (US)

(21) Appl. No.: 18/929,309

(22) Filed: Oct. 28, 2024

Related U.S. Application Data
(60) Provisional application No. 63/593,837, filed on Oct. 27, 2023.

(51) Int. Cl. A01B 63/111; A01B 69/00; G01B 7/00; G01P 3/50

(52) U.S. Cl. CPC A01B 63/111; A01B 69/004; G01B 7/003; G01P 3/50

(57) ABSTRACT

An agricultural implement control system, comprising at least one position sensor in association with at least one actuator and a processor in communication with the at least one position sensor configured to determine a position of the at least one actuator. The system where the at least one position sensor comprises a magnetometer and a magnet. The system including a controller wherein is controller is configured to start and stop an implement operation based on the position of the at least one actuator.

### CROSS-REFERENCE TO RELATED APPLICATION(S)

This application claims the benefit under 35 U.S.C. § 119(e) to U.S. Provisional Application 63/593,837, filed Oct. 27, 2023, and entitled Agricultural Implement Position Sensor and Related Devices, Systems, and Methods, which is hereby incorporated herein by reference in its entirety for all purposes.

### TECHNICAL FIELD

The disclosure relates to agricultural implements and positions sensors for use therewith.

### BACKGROUND

There are many known sensors that are used to provide actuator position, travel direction, and travel speed. Many of these known sensors require that the sensor is included in the construction of the actuator. Other prior known sensors can be installed external to actuator but are difficult to install and/or are not well suited to an external environment, such as on a farm implement where conditions can be severe including dust, debris, and water. Mechanical limit switches are known and can provide end of travel response but do not provide continuous feedback as the actuator moves through a range of travel.

### BRIEF SUMMARY

In Example 1, a sensor for use on an agricultural implement for determining a position of a mechanism, the sensor in communication with an autonomous controller, wherein the autonomous controller verifies position prior to taking an action.

Example 2 relates to the sensor of any of Examples 1 and 3-5, wherein the sensor is a magnetometer and further comprising a magnet disposed on the agricultural implement in proximity to the magnetometer.

Example 3 relates to the sensor of any of Examples 1-2 and 4-5, wherein the mechanism comprises a cylinder and a rod.

Example 4 relates to the sensor of any of Examples 1-3 and 5, wherein a 3-dimensional reading of the magnetometer is correlated to a stroke of a cylinder.

Example 5 relates to the sensor of any of Examples 1-4, further comprising a processor in communication with the sensor the processor configured to calibrate the sensor and determine a position of the cylinder based on the calibrated sensor.

In Example 6 a non-contact method of determining a position and velocity of a linear actuator on an agricultural implement, comprising calibrating at least one sensor in association with the linear actuator; recording 3-dimentional positions of the at least one sensor during operations; and determining the position and velocity of the linear actuator from the recorded 3-dimentional position of the at least one sensor.

Example 7 relates to the method of any of Examples 6 and 8-9, wherein the at least one sensor is a magnetometer and magnet.

Example 8 relates to the method of any of Examples 6-7 and 9, further comprising executing one or more operation on the agricultural implement based on the position and velocity of the linear actuator.

Example 9 relates to the method of any of Examples 6-8, further comprising comparing the position and velocity of more than one linear actuator.

In Example 10, an agricultural implement control system, comprising at least one position sensor in association with at least one actuator and a processor in communication with the at least one position sensor configured to determine a position of the at least one actuator.

Example 11 relates to the agricultural implement control system of any of Examples 10 and 12-20, wherein the at least one position sensor comprises a magnetometer and a magnet.

Example 12 relates to the agricultural implement control system of any of Examples 10-11 and 13-20, further comprising a controller wherein the controller is configured to start and stop an implement operation based on the position of the at least one actuator.

Example 13 relates to the agricultural implement control system of any of Examples 10-12 and 14-20, wherein the implement operation is autonomous implement folding and unfolding.

Example 14 relates to the agricultural implement control system of any of Examples 10-13 and 15-20, wherein the implement operation is autonomous implement raising and lowering.

Example 15 relates to the agricultural implement control system of any of Examples 10-14 and 16-20, wherein the processor is further configured to determine velocity of the at least one actuator.

Example 16 relates to the agricultural implement control system of any of Examples 10-15 and 17-20, further comprising a feedback position control system configured to define a target position; measure an actual position; calculation a position error from the target position; and command a valve to correct the position error.

Example 17 relates to the agricultural implement control system of any of Examples 10-16 and 18-20, wherein the feedback position control system is configured to calculate velocity error.

Example 18 relates to the agricultural implement control system of any of Examples 10-17 and 19-20, wherein the at least one position sensor provides a 3-dimensional reading.

Example 19 relates to the agricultural implement control system of any of Examples 10-18 and 20, further comprising a calibration system configured to calibrate the at least one position sensor to determine if the at least one actuator is operating normally.

Example 20 relates to the agricultural implement control system of any of Examples 10-19, wherein the at least one position sensor is a non-contact sensor.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a perspective view of a sensor, according to one implementation.

FIG. 2 is a side view of a sensor, according to one implementation.

FIG. 3 is a system diagram of the sensor system, according to one implementation.

FIG. 4 shows an exemplary cylinder and pivot for use with the system, according to one implementation.

FIG. 5 shows an exemplary cylinder and rod, according to one implementation.

FIG. 6 shows an exemplary cylinder and rod, according to one implementation.

FIG. 7 shows an exemplary cylinder and rod, according to one implementation.

FIG. 8 shows an exemplary magnet and sensor, according to one implementation.

FIG. 9 is a graph showing sensor data curves, according to one implementation.

FIG. 10 is a graph showing sensor data curves, according to one implementation.

FIG. 11 is a flow diagram showing a sensor calibration method, according to one implementation.

FIG. 12 is a flow diagram showing sensor calibration for systems having more than one mechanism, according to one implementation.

FIG. 13 depicts a feedback position command loop, according to one implementation.

FIG. 14 depicts the control system executing a feedback position command loop, according to one implementation.

FIG. 15 depicts the control system executing a feedback position command loop, according to one implementation.

FIG. 16 depicts the control system executing a feedback position command loop, according to one implementation.

FIG. 17 depicts the control system executing a feedback position command loop, according to one implementation.

FIG. 18 depicts the control system executing a feedback position command loop, according to one implementation.

FIG. 19 depicts the control system executing a feedback position command loop learning model, according to one implementation.

FIG. 20 depicts the control system executing a feedback position command loop learning model, according to one implementation.

### DETAILED DESCRIPTION

Disclosed herein are various sensors and related systems and methods configured to provide feedback on the status of various actuated mechanisms of an implement. Various implementations are used in conjunction with autonomous tractors, such that an autonomous controller can verify conditions before taking or continuing an action, as would be appreciated. As would be understood, autonomous controllers require feedback from sensors because there is no resident operator to visually check on machine status/performance. Alternatively, if an operator is present an autonomous controller/feedback system may free the operator to focus on other concerns without interruption from needing to monitor the various components of the machine as described herein.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,”U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/776,374, filed Jul. 8, 2024, entitled “Assisted Steering Systems and Associated Devices and Methods for Agricultural Vehicles,” U.S. Patent Application 63/593,837, filed Oct. 27, 2023, entitled “Agricultural Implement Position Sensor and Related Devices, Systems, and Methods,” U.S. Patent Application 63/603,969, filed Nov. 29, 2023, entitled “Devices, Systems and Methods for Guidance Line Shifting,” U.S. Patent Application 63/607,227, filed Dec. 7, 2023, entitled “Header Height Control Devices, Systems and Methods,” U.S. Patent Application 63/609,758, filed Dec. 13, 2023, entitled “Magnetic Stripper/Deck Plate Sensing System,” U.S. Patent Application 63/626,744, filed Jan. 30, 2024, entitled “Grain Cart Unloading Sensor and Unload Control,” U.S. Patent Application 63/646,038, filed May 13, 2024, entitled “Seed Tube Camera and Related Devices, Systems, and Methods,” U.S. Patent Application 63/646,068, filed May 13, 2024, entitled “Seed Tube Camera and Related Devices, Systems, and Methods,” U.S. Patent Application 63/651,831, filed May 24, 224, entitled “Non-Contact Methods for Interactions in Navigational Space of Relatively Located Mobile Systems, and Related Devices and Systems,” U.S. Patent Application 63/654,634, filed May 31, 2024, entitled “Equipment Thermal Monitoring System and Associated Methods and Devices,” U.S. Patent Application 63/667,546, filed Jul. 3, 2024, entitled “Cover for Port Openings,” U.S. Patent Application 63/667,530, filed Jul. 3, 2024, entitled “Agricultural Seed Meters and Related Devices, Systems and Methods,” U.S. Patent Application 63/685,000, filed Aug. 20, 2024, entitled “Crop Sensor Wands and Related Devices, Systems, and Methods,” U.S. Patent Application 63/682,229, filed Aug. 12, 2024, entitled “Integrated Crop Sensor and GPS Steering Systems and Related Devices and Methods,” U.S. Patent Application 63/683,149, filed Aug. 14, 2024, entitled “Seed Tube Camera and Related Devices, Systems, and Methods,” U.S. Patent Application 63/710,492, filed Oct. 22, 2024, entitled “Crop Sensors and Related Devices, Systems, and Methods,” U.S. Patent Application 63/710,641, filed Oct. 23, 2024, entitled “Agricultural Sprayer Boom Flush, Chemical Detection and Chemical Concentration Detection,” each of which is incorporated herein by reference.

Provided herein is a non-contact sensor that can be installed in a variety of conditions that will provide continuous position, travel direction, and/or movement speed monitoring of an actuator driven mechanism. The various devices, systems, and methods disclosed herein are configured to detect movement/positioning of devices used on a tractor/implement including, for example: 1) raising/lowering an implement (optionally to a proper height for turning around for a next pass); 2) folding/unfolding large implements (optionally when exiting or entering a field area); and/or 3) mechanical system fault detection (optionally, for system shut down/stoppage to prevent problem aggravation/continuation). Various further use cases for the devices, systems, and methods described herein are possible and would be apparent to those of skill in the art.

The sensor and associated systems may be used on implements with lifting arms that rotate as the machine raises and lowers. The sensor and associated systems may also be useful to automate folding and unfolding sequential operations. For example, as would be understood, the wings of an implement must be folded before the wheels that support the wings in the field can be raised to allow for transport.

Many implements have a sequence of operations they use repeatedly in the field as they make repeated passes. These may include raise/lower (lift cylinder extend/retract sequences). For example, the implement may raise to a predetermined height for field turns.

When the implement needs to be transported there are often folding sequences that are used more rarely but are more complicated and would previously require input and observation from an operator. In this example, the same lift cylinders used for raising/lowering during turns may be allowed to extend to a second further extension position to raise the toolbar and the ground engaging tools high enough to clear the implement tires. Once raised to a second toolbar height another set of actuators may cause the implement to fold the wings of the implement forward to narrow the transport width. When folded for transport, some of the implement tires may be perpendicular to the direction of travel. A third set of inputs is required to lift the tires off the soil surface so the machine can be transported to the next destination. In implementing the disclosed system, automation of this folding/unfolding sequence is possible by knowing the position of each of the actuators in the sequence.

The various sensors described herein, may be used with 8″ and 12″ stroke hydraulic cylinders that are used to lift common toolbar type implements. While various other applications are possible and would be understood by those of skill in the art.

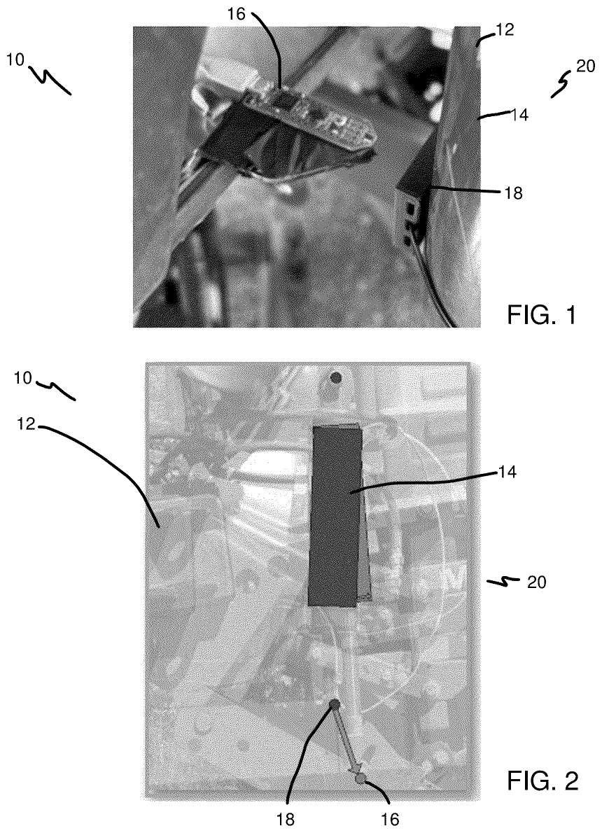

Turning to the figures in more detail, in various implementations, the sensor or sensor system 10 utilizes a magnetometer 16 or similar type sensor 16, to read the change in position of an actuator, such as a planter 12 lift wheel arm, or the cylinder 14 barrel as the actuator 20 goes through a lift/retract stroke, show variously in FIGS. 1 and 2. In these and other implementations, the 3-dimensional reading on the magnetometer 16 is correlated to the stroke of the cylinder 14. This correlation can be used to determine the speed of the cylinder 14 travel and the position of the cylinder 14 rod as it extends and retracts. The correlation can also be used to compare the stroke position of multiple cylinders 14 so they can be timed with each other for position control using pulse width module (PWM) flow control valves or similar devices for position mechanism as would be understood.

In various implementations, the system 10 is installed by mounting a magnet 18 on one surface and mounting a magnetic sensor 16 on an adjacent surface. It is necessary that there is constant and relative motion between the two surfaces that is a direct result of the extension and retraction of the actuator 20.

One advantage of magnetic sensors 16 is they can “see through”/be read through any non-ferrous substance that may come between the magnet 18 and sensor 16. This is an advantage in farm machinery applications that operate in dirt, mud, dust, plant debris, lighting variances, temperature variances, and the like. Optionally, the sensor 16 and magnet 18 can be held in non-ferrous protected housings, such as plastic or aluminum. By housing the sensor 16 and magnet 18 in protective housings, the sensor system 10 is able to survive and operate in harsh environments, such as that outside of a cylinder 14.

These magnetic sensors 16 are a low cost, non-contact way to provide implement position feedback on implements used in autonomous conditions or when semi-autonomous conditions are desirable.

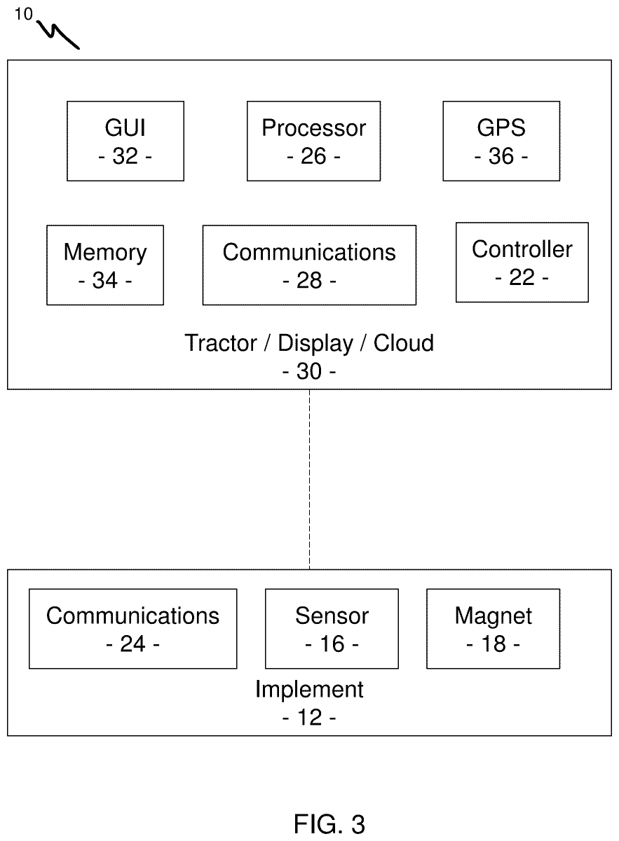

Turning to FIG. 3, in various implementations, the sensor 10 and associated systems and methods can provide feedback to an autonomous controller 22, user, control system, or the like to determine if an implement 12 is fully raised (such as to determine if it is ok to turn around); if a cultivator 12 needs to be raised to mitigate wheel slip; and other information as would be understood.

In various implementations, the system 10 includes various software, hardware, and firmware components needed to execute the programs and methods of the system 10. Optionally, the implement 12 may include a communications component 24 configured to convey data from the sensor 16 to a tractor/display/cloud 30 for further processing by the processor 26.

The display 30 may optionally include a communications component 28 configured to send and receive instructions for operation of the system 10, implement 12, and components thereof. The display may also optionally include a graphical user interface (GUI) 32, a memory/storage 34, a global positioning system (GPS) 36, and other components necessary to effectuate the methods of the system 10.

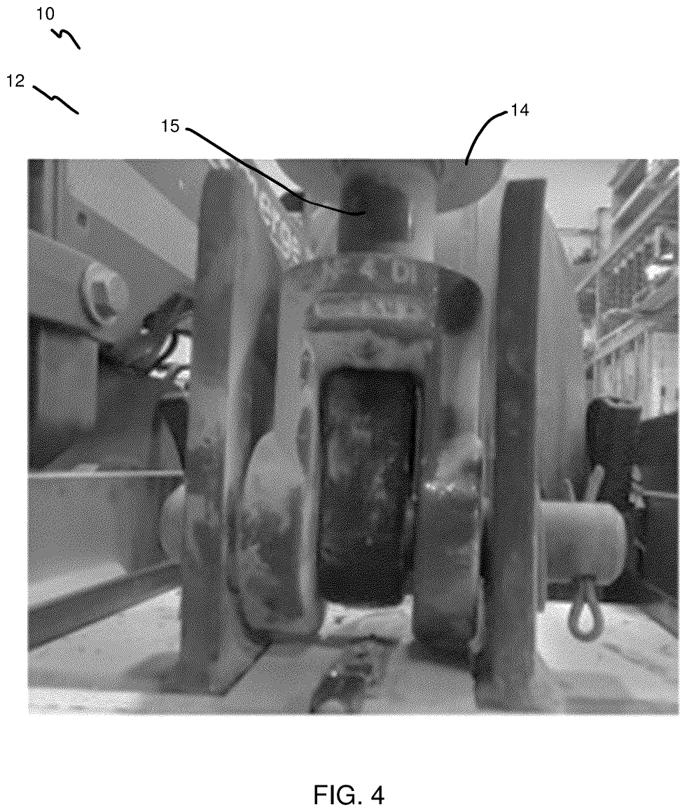

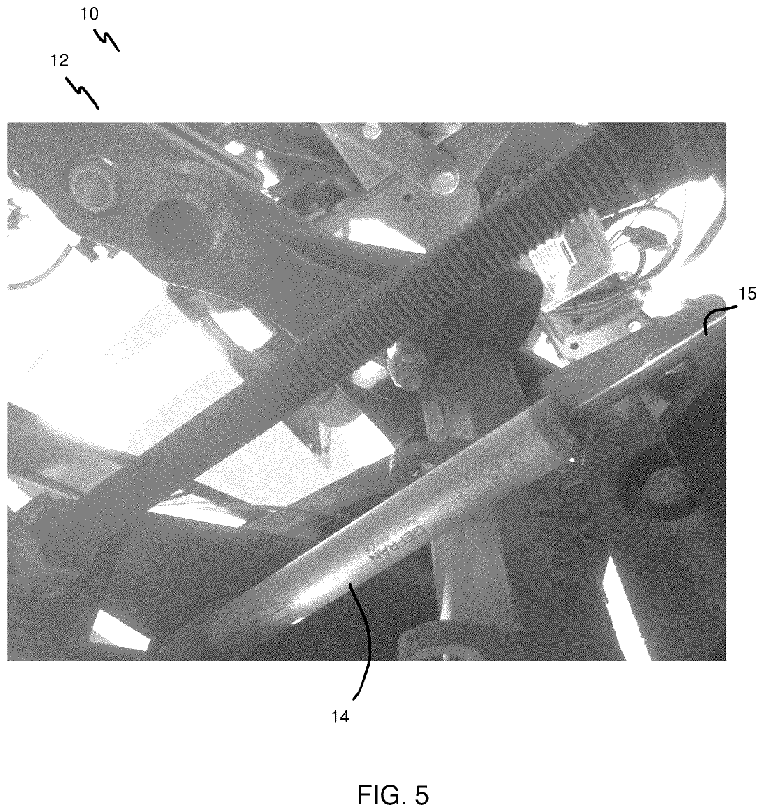

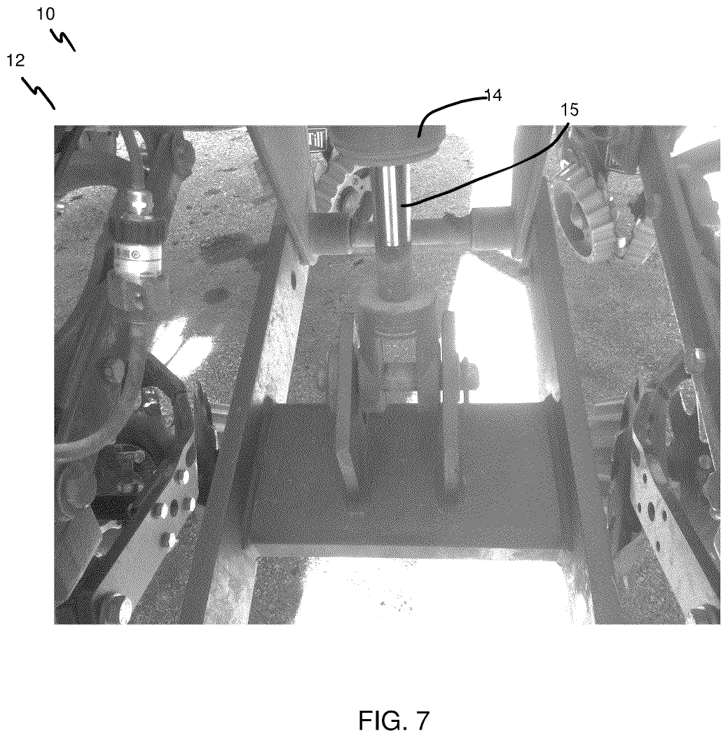

FIGS. 4-7 show various implementations the system 10 and an actuator cylinder 14 and rod 15 on an agricultural implement 12. Alternatively, the sensor 16 may be matched to an actuator.

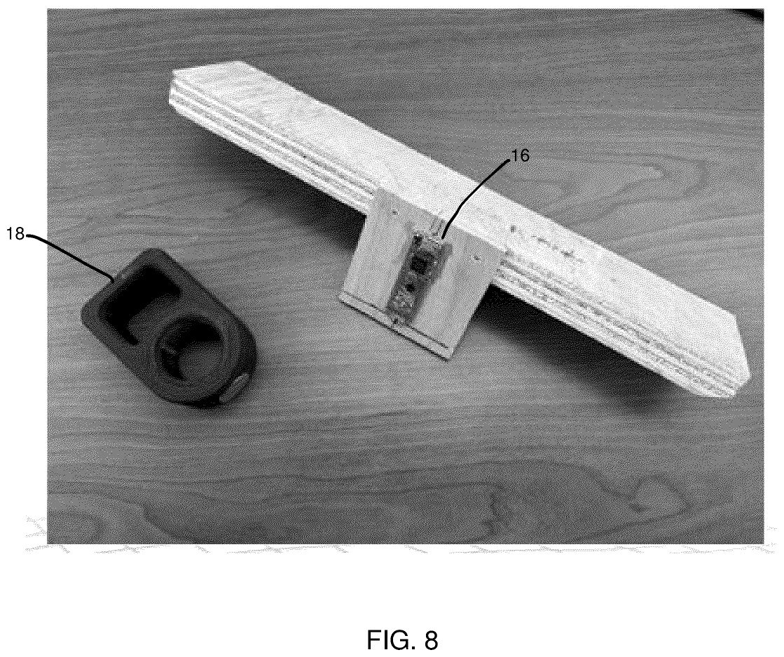

FIG. 8 shows one example of a magnet 18 and sensor 16 prior to installation on an implement. Various mechanism and devices for mounting the magnet 18 and sensor 16 to appropriate locations on an implement 12 are possible and would be understood, including, but not limited to, adhesive, mechanical fastener (e.g., screw, nails, bolt, etc.), rings, ties, and the like.

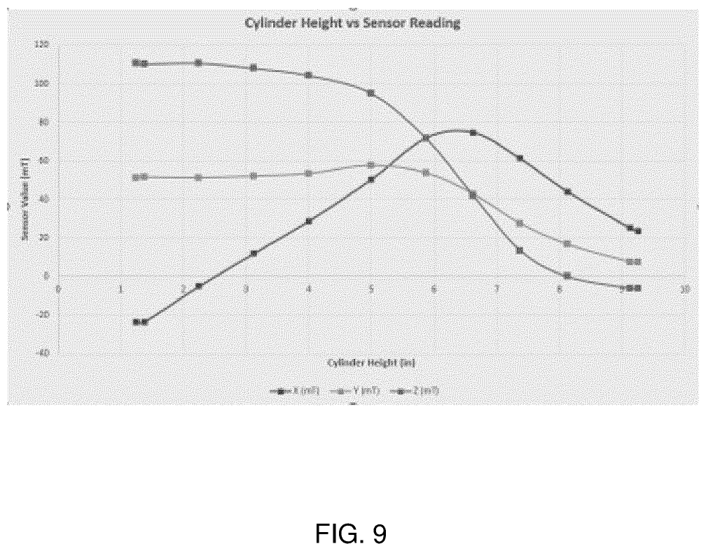

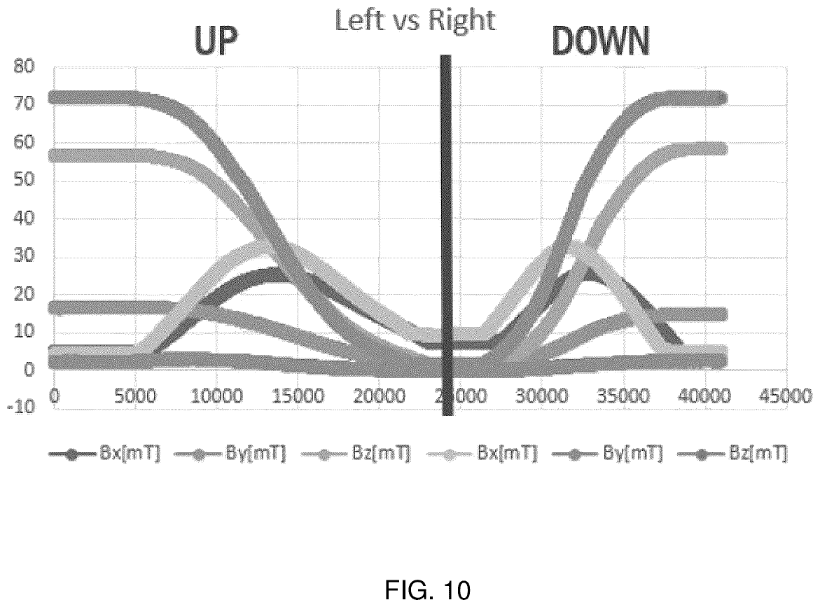

Turning to FIGS. 9 and 10, in various implementations, the sensor 16 provides feedback as a 3-dimensional output (X, Y, and Z directions). FIG. 9 shows exemplary response curves that may be generated by the sensor 16 from one mechanism operated by one actuator. FIG. 10 shows exemplary response curves form two parallel mechanisms operated by separate actuators operating in unison.

In various implementations, the system 10 operates by performing calibration, discussed further below, and recording X, Y, and Z trace patterns from the sensor 16. The system 10 may then compare subsequent sequences of X, Y, and Z trace pattern for each time the actuator is extended or retracted. When comparing the system 10 looks for the trace patterns to be the same during operation and calibration to indicate normal function. Differences, such as sudden changes, in the trace patterns may indicate malfunction and/or mechanical failure. If malfunction and/or mechanical failure is detected the system 10 may automatically or semiautomatically stop the operation to allow for further assessment.

In various implementations, the system 10 may optionally allow for some nominal drift in the trace patterns, which may be caused by temperature effects and other anticipated effects on the components. In certain implementations, the system 10 accounts for a certain threshold difference in the trace patterns that can be attributed to wear. If the threshold amount of difference is exceeded, indicating abnormal wear or other malfunction an alert may be issued to a user.

The various sensors described herein can be trained to learn the position based on movement of the mechanism. In certain implementations, a calibration system 50 may be used to train the control system 10. Optionally the calibration system 50 may train the system 10 as to what is the expected normal feedback, that is, the sensor 16 and system are calibrated for normal operation. The various methods and programs for calibration and training may comprise a series of steps and substeps, each of which is option and may be performed in any order or not at all. Various of the steps and substeps may be executed sequentially, concurrently, iteratively, or ad hoc, as would be understood and appreciated by those of skill in the art.

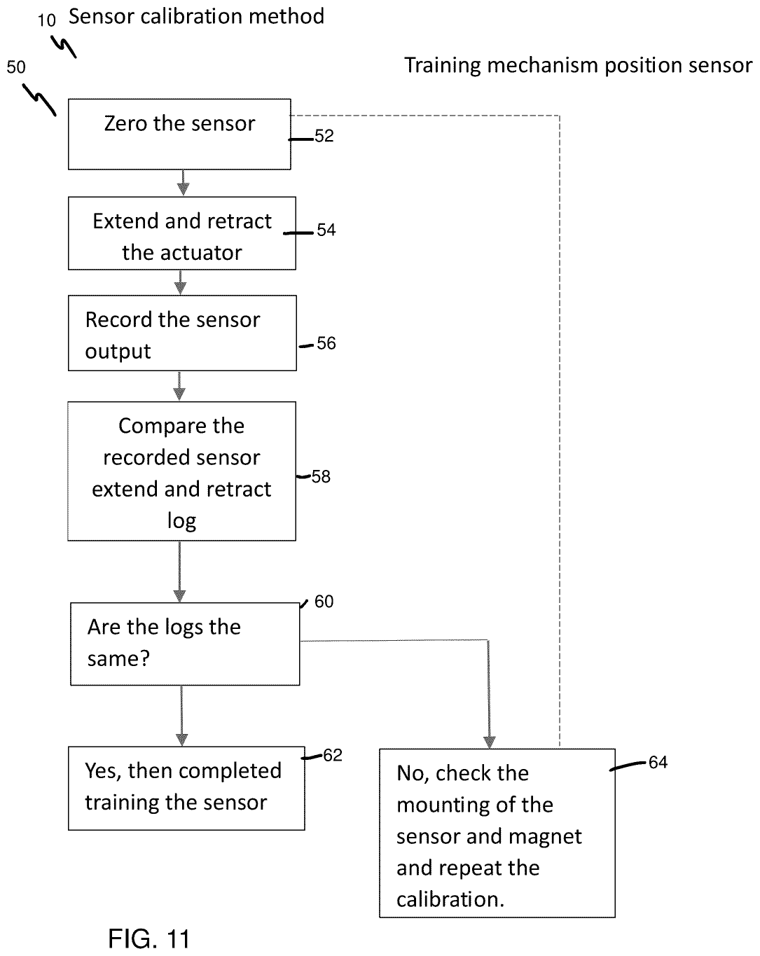

FIG. 11 illustrates an exemplary method for sensor 16 calibration, and/or training mechanism for a positions sensor 16. In a first optional step, the sensor 16 is zeroed (box 52). That is the sensor 16 is placed in a neutral or resting position and the sensor 16 reading set to zero (box 52).

In a second optional step, the actuator is extended and retracted (moved through its normal range of motion) (box 54). In a further optional step, the sensor 16 output is recorded (box 56). The recorded sensor extend and retract log may then be compared (box 58).

In a further optional step, the calibration system 50 determines if the extend and retract logs are the same (box 60). If the extend and retract logs are the same the calibration is completed (box 62). In the logs are not the same the system 10 may prompt a user to check the mounting of the sensor 16 and magnet 18 and repeat the calibration (box 64).

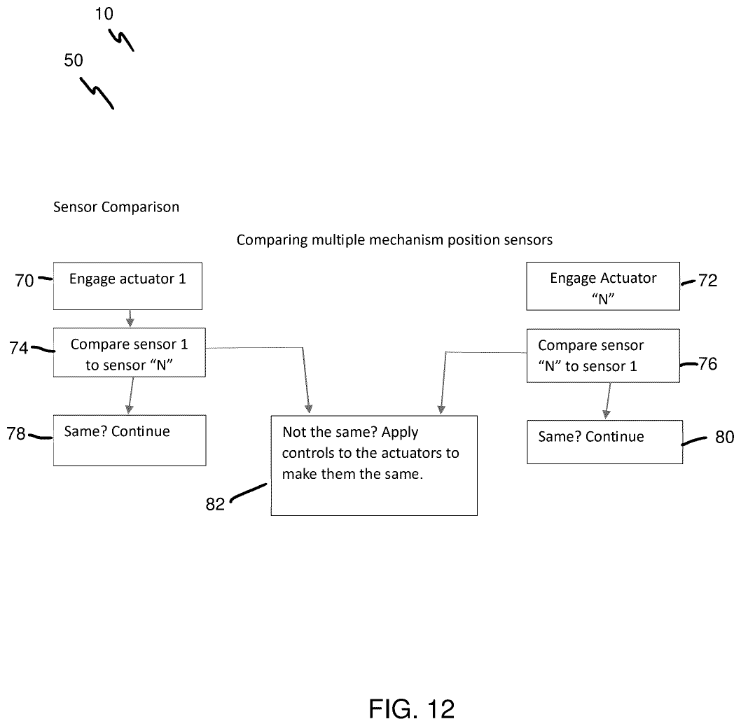

In implementations having more than one position sensor 16 and more than one mechanism/actuator, the calibration system 50 may compare the positions sensors 16 to each other. An exemplary calibration method for such a system 10 is shown for example in FIG. 12. In one step, a first actuator is engaged (box 70) and a second actuator is engaged (box 72). It would be understood, that any number of actuators and sensors may be implanted by the system 10. Only two will be discussed it this example, but it would be understood that there could be three, four, five, or more.

In a further step, the first sensor is compared to the second sensor (box 74) and the second sensor is compared to the first sensor (box 76). The system 50 may then determine if the reading for the sensors are the same (boxes 78 and 80). If so, calibration is complete. If not, controls are applied to the actuators to make them the same (box 82), as will be discussed further herein.

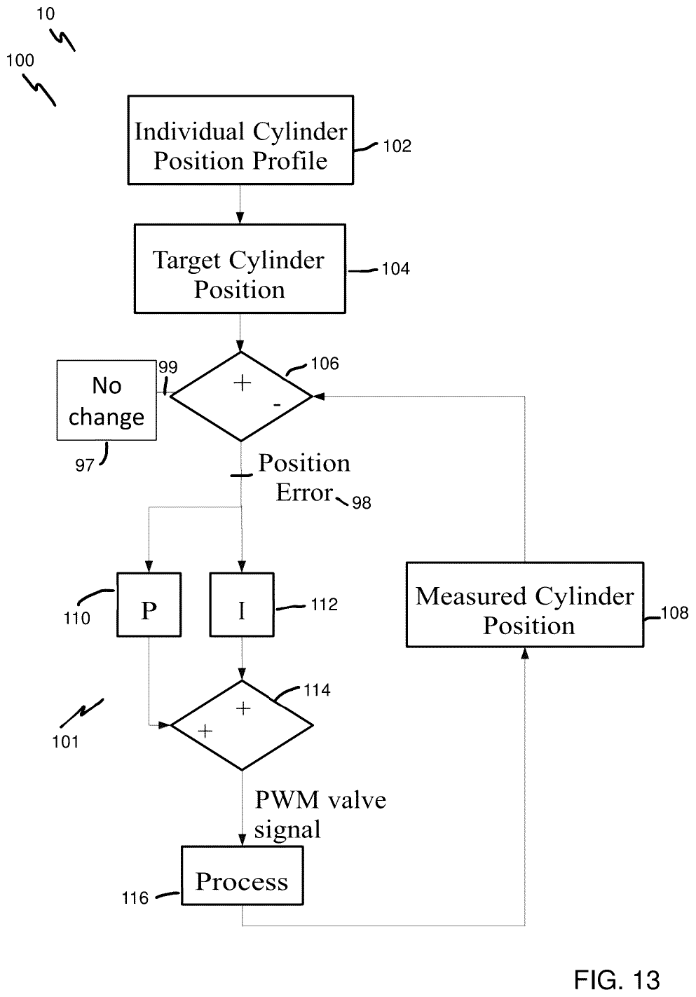

FIG. 13 depicts an exemplary implementation of the control system 10 the described utilizing a feedback position command system 100 to control an individual cylinder 14 on the basis of feedback received from the position sensors 16 and other data provided to the system 10. In this implementation, the feedback position command loop 100 compares an actual position with a defined target position established by the system 10. It is appreciated that in use according to certain implementations, the defined target position changes over time, and that the received position sensor data is processed as a time-series of values.

In the implementation of FIG. 13, a desired individual cylinder profile (box 102) for the cylinder is given, which can be based on the desired arrangement and position of the assemblies based on historical performance, programmed commands, user input or the like, each individual cylinder has a position that the system 10 will direct the valves to achieve efficiently. For example, if the design of the implement requires some cylinders to extend at a different rate than others to lift the implement properly, the control system 10 can be configured to cause that controlled motion by assigning differentiated profiles to specific sets of cylinders.

In the implementation of FIG. 13, for example, the profile (box 102) is inputted as a defined target position (box 104), which can be compared to the actual position (box 108) of the cylinder based on the time-series position sensor data derived from the position sensor 16 on the cylinder over time to calculate a position error (box 106). According to certain implementations, the position error (box 106) is calculated by comparing the measured cylinder position (box 108) to the target cylinder position (box 104) to calculate a position error value. In the event that a non-zero position error (or position error which exceeds a defined threshold or deadband) is detected, the system 10 proceeds to execute a proportional integral (PI) control loop 101 (shown at 98). While a PI control loop is one such example of a feedback control loop, other similar loops are of course possible, as would be understood.

It is understood that in the event that there is no position error, or if it is within a defined deadband or threshold established by the system and/or user (shown at line 99), no change in action (box 97) will be commanded. It is further understood that the calculation of position error (box 106) in these and other implementations is performed continuously over time such that while the implement is being activated, the position error may change continually.

In use according to these implementations, in the event that a position error is present (98), the PI control loop 101 is able to direct increased relative flow rate via a change in pulse-width modulation (PWM) command to a lagging assembly and increase the cylinder's rate of extension or retraction via proportional (box 110) and integral (box 112) control commands that are combined (box 114) and issued to command a change in PWM valve signal to the cylinders (shown in real-time execution as process, box 116). It is understood that actual cylinder position (box 108) continues to be recorded and that the control system 10 and feedback position command loop 100 both continue to proceed as described. Those of skill in the art will appreciate that the combination of proportional and integral control can provide both immediate and persistent adjustment to lagging cylinders in certain implementations, but in further implementations additional feedback control systems and approaches can also be incorporated as appropriate.

That is, while these implementations utilize one version of a PI control loop, it is well-appreciated that other implementations can use alternate PI control configurations, proportional integral derivative (PID) loop configurations, and other control loop feedback mechanisms as would be well-appreciated in the art.

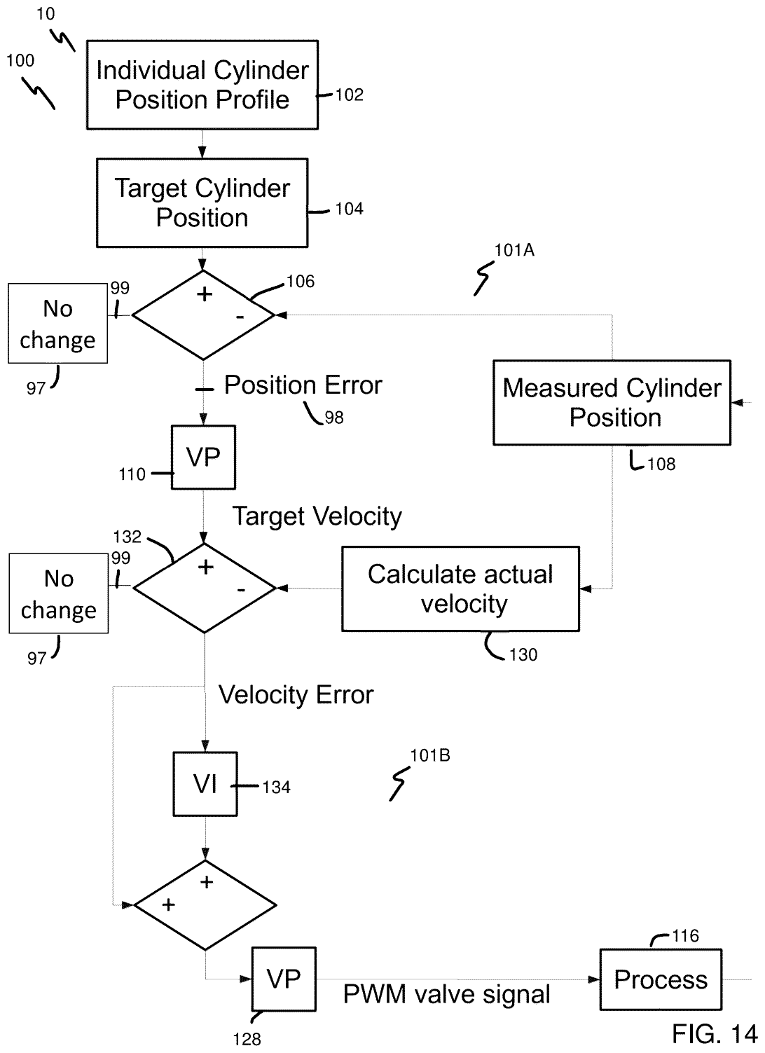

In the exemplary implementation of FIG. 14, the control system 10 utilizes a feedback position command loop 100 comprising a position control PI loop 101A where the target position (box 104) and measured position (box 106) are compared, and if the result is non-zero or in excess of a defined deadband or threshold (line 98), a nested velocity control PI loop 101B is executed, wherein the position error (box 106) is inputted into a proportional control (box 110) to establish a target velocity that is compared to the actual velocity (box 130) derived from the measured cylinder position (box 108) to calculate a velocity error (box 132), which (if not non-zero or within defined deadband/thresholds, line 99) is inputted (line 96) into the velocity control loop 101B.

In the velocity control loop 101B, the proportional of the velocity control loop (box 128) and integral of the velocity control loop (box 134) are combined (box 136) to command a PWM signal to the control valve to minimize velocity error. In this control system 10 implementation, it is appreciated that larger position errors will correspond to larger target velocity and accordingly higher PMV signals. And in turn, these higher velocities will more quickly eliminate the position error.

As an illustrative example of the application of the use of such a feedback position command loop 100, take a given cylinder currently at the desired cylinder position of 1″ extension at zero velocity. Under these conditions, the cylinder has zero position error (box 106) and zero velocity error (box 132), and as such no change is required to the command. Subsequently, the operator issues a command (such as from the display or other in-cab system) defining the target position (box 104) to 10″ of extension for this cylinder. As the cylinder is at 1″, the position error is now instantly at of 9″. This error (box 106) passes to a P-gain action at the proportional (box 110) that generates a proportional target velocity. In this instance, assume a P-gain of 2×.

Accordingly, the target velocity is 9*2=18. Actual velocity is still zero, so the velocity error is 18−0=18. The velocity P and I actions (boxes 128 and 134) will therefore generate a corresponding PWM signal for the valve to increase hydraulic flow or pressure maximally.

After a period of time, the cylinder is now moving toward the defined target position. It's currently at 4″ and the target is still 10″. Position error is 10″−4″=6″. Target velocity is position error*P-gain. 6*2=12. Assume current velocity is 13, so velocity error is 12−13=−1. So the PWM signal will be reduced accordingly. As the cylinder continues to approach the target position, the target velocity will steadily reduce, until target velocity drops to zero when the cylinder reaches 10″. It is thus appreciated that in a population with a relatively limited overall hydraulic capacity, such differences in commands at the individual cylinders thus results an efficient allocation of pressure and more immediate response in the system. It is further appreciated that this is given to demonstrate one illustrative example according to an application of the implementation of FIG. 14, but is in no way intended to be limiting.

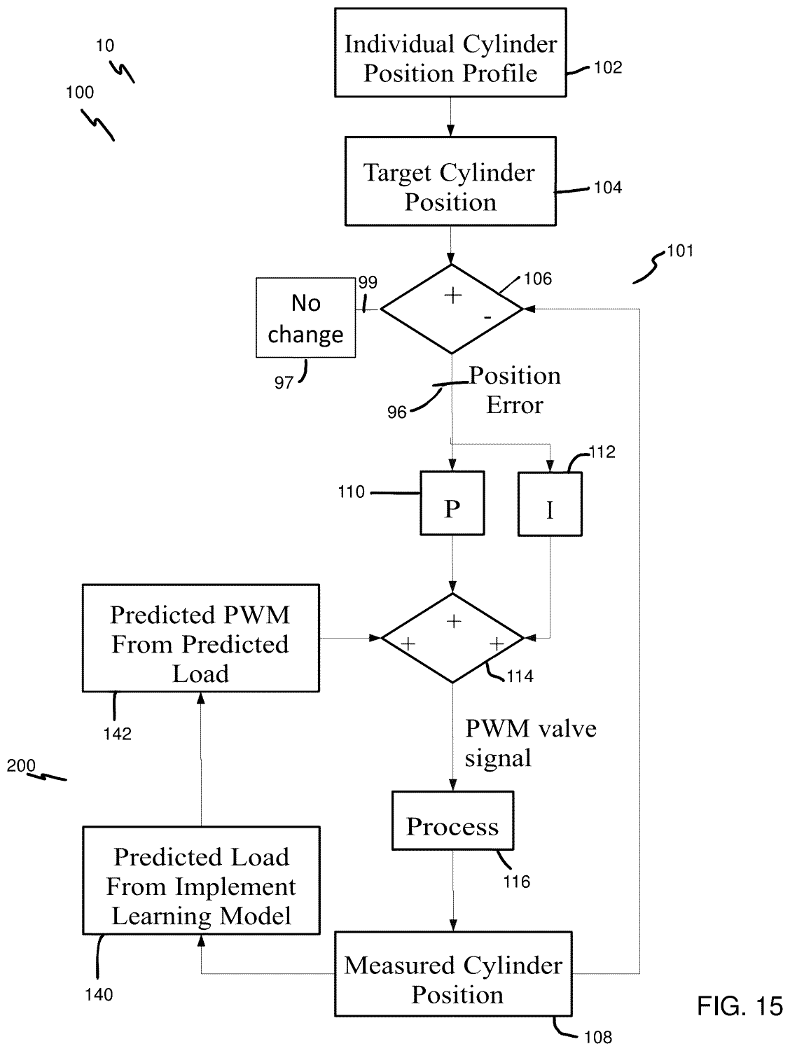

Returning to the figures, in the implementation of FIG. 15, the control system 10 comprises a feedback position command loop 100 having a PI control loop 101 where in the event of a detected position error (box 106), the position error is inputted for application of proportional (box 110) and integral (box 112) control commands and the actual cylinder position (box 108) is also inputted into a model-based feed-forward control system to determine a predicted load (box 140) via an implement learning model, which can in turn be used to predict the pulse wave modulation (box 142) which can be combined with the proportional (box 110) and integral (box 112) control commands to modify the PWM valve signal (box 114) and execute the process (box 116), as would be appreciated. It is appreciated that in such implementations the system 10 thereby makes use of a learning or performance model 200 to optimized system 10 performance. Further implementations can make use of additional model predictive control technologies, such as a learning-based model predictive controller and the associated and similar approaches. In various implementations, the performance model can be configured to identify potential failures, modify thresholds or adjust control loop parameters, such as the proportional and integral controls for position and/or velocity.

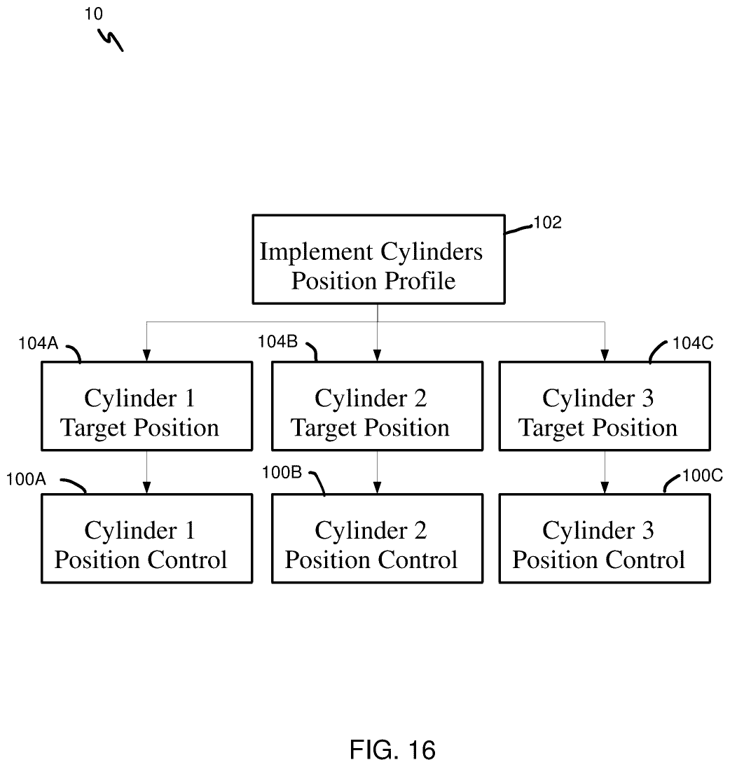

In the implementation of FIGS. 16-18, the control system utilizes position profiles (box 102) to coordinate a plurality of cylinders moving as a group. In these implementations, the target positions (boxes 104A, 104B, 104C) for several cylinders are established together and the system 10 utilizes position control (boxes 100A, 100B, 100C) on the cylinders to accomplish unified or otherwise coordinate movement.

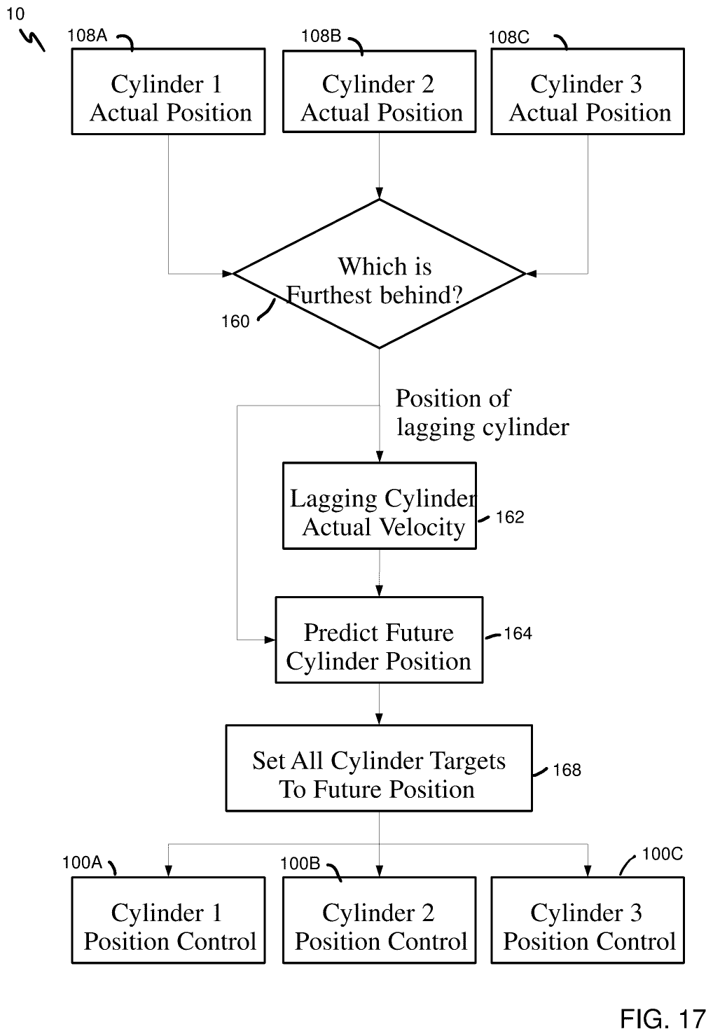

In the implementation of FIG. 17, the position command system 100 can be performed on several coordinated cylinders. In these implementations, for example, the actual positions of the cylinders based on the time-series position sensor data (boxes 108A, 108B, 108C) can be compared to establish if there is a lagging cylinder that is “furthest behind” (box 160). Actual velocity of the lagging cylinder can be calculated (box 160, future cylinder position predicted (box 164) and the targets of all cylinders can be adjusted to account for the calculated future positions (box 166), as shown. In various implementations, the flow to the lagging cylinder can accordingly be increased to account for the lag and bring the cylinders into alignment, as would be understood.

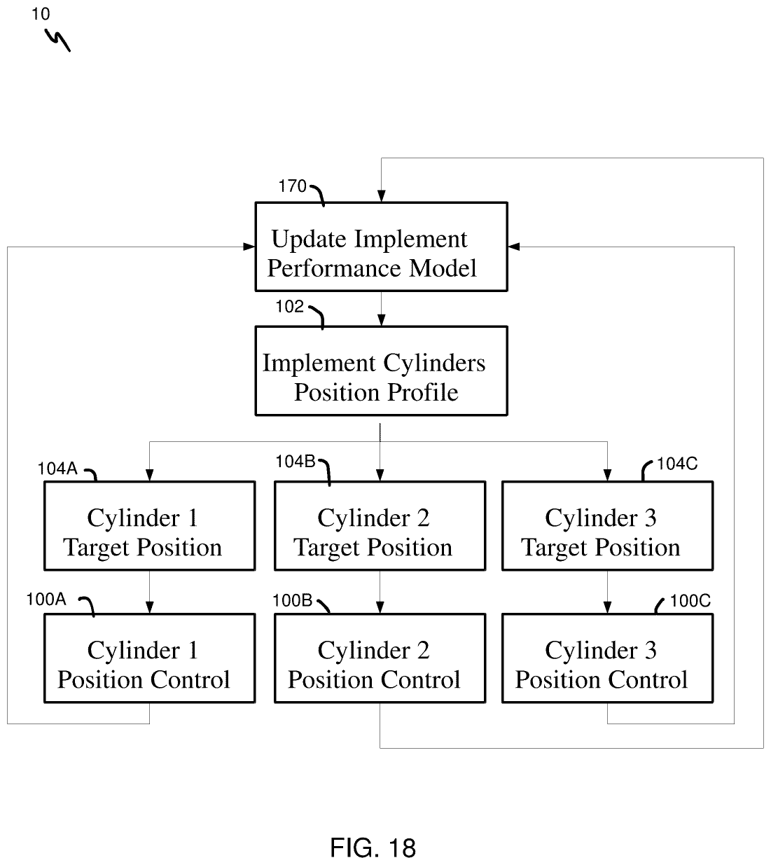

FIG. 18 depicts an implementation of the system 10 wherein a performance model (box 170) is used to establish and update the position profiles (box 102) based on feedback derived from the position control (boxes 100A, 100B, 100C) being inputted (lines 172A, 172B, 172C) into the model (box 170).

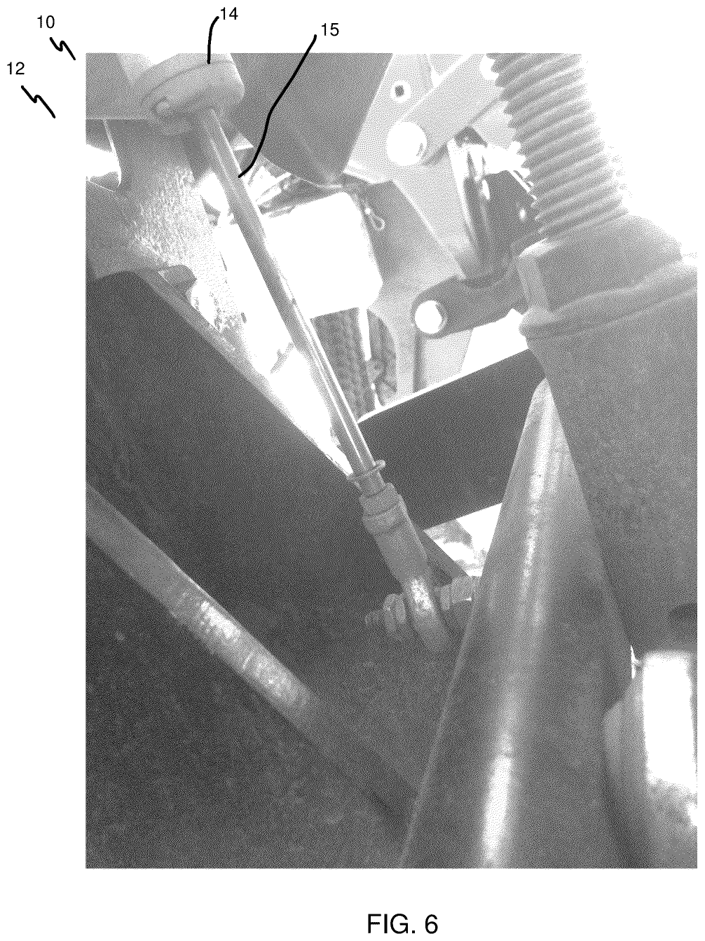

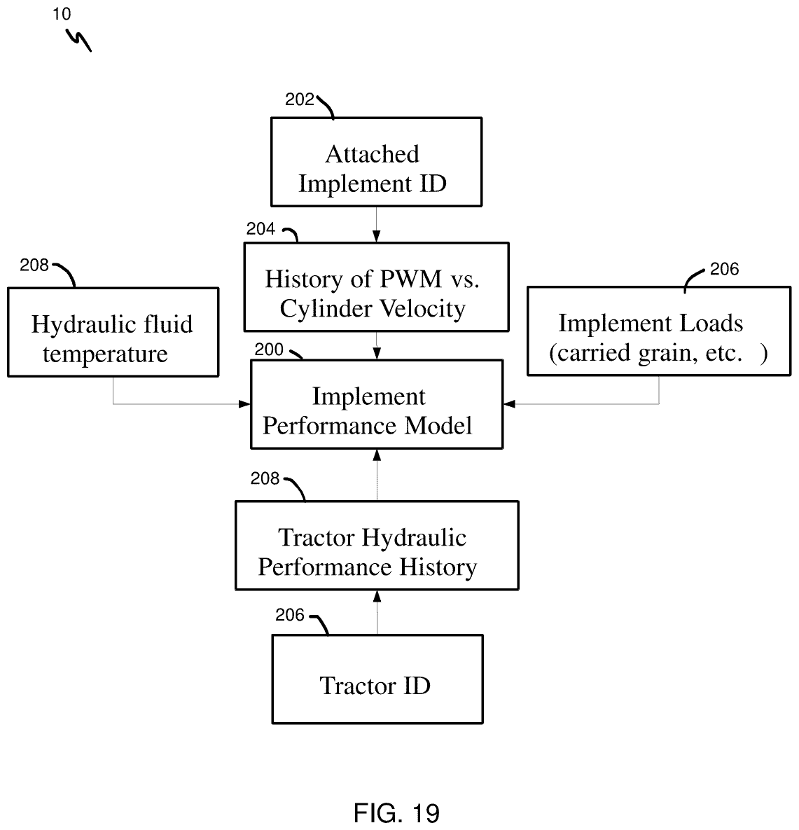

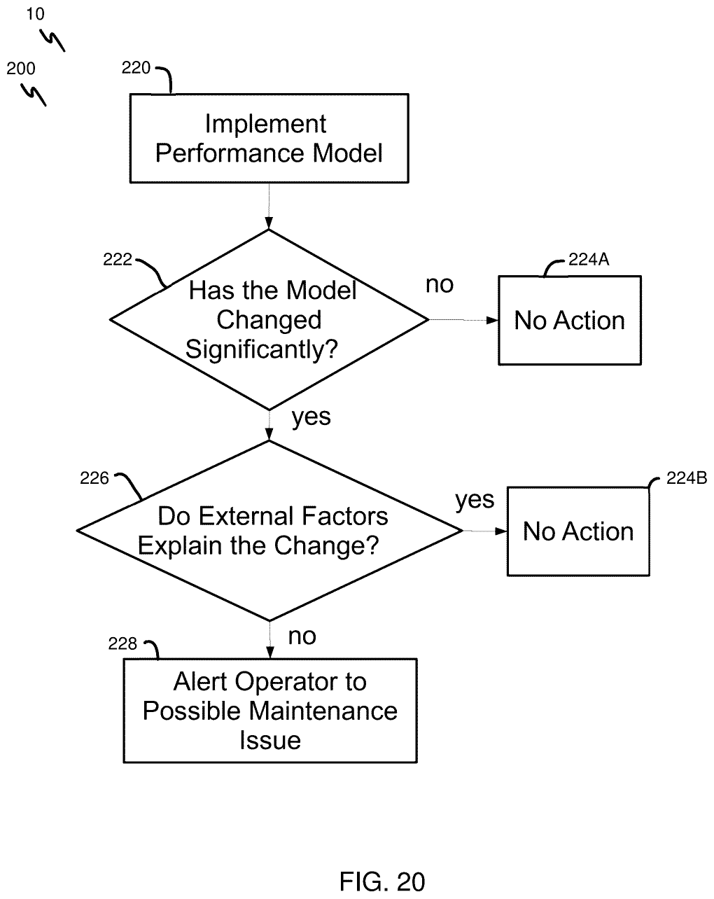

FIGS. 19-20 depict various implementations of a learning implement performance model (box 200) and how it can be utilized by the system 10 to inform an operator of potential maintenance issues. That is, feedback from the control system 10 and/or information about the particular implement and its performance can advise the operator of potential machine failures and service needs. For example, if a particular cylinder 16 is requiring increasing amounts of lift pressure or is becoming increasingly slow to extend θ′ or retract θ over time, a potential bearing failure could be the cause. It is appreciated that this information can be provided to the operator via the display (shown in FIG. 6A at 52) or otherwise.

In the implementation of FIG. 19, the performance model (box 200) is able to utilize various optional data inputs to improve implement performance and uptime. Certain of these data inputs can include the identity of the attached implement (box 202) and, optionally, the historical performance of the PMW vs. actual cylinder velocity (box 204) as, for example recorded by the implement or inputted from more widely available results. Tractor type identity (box 206) and historical hydraulic system performance (box 208) can likewise be inputted into the performance model (box 200).

In various implementations, and as also shown in FIG. 12, real-time readings such as the hydraulic fluid temperature (box 210) and or the implement loads (box 212) can also be inputted into the performance model (box 200) for use in assessing and optimizing the performance of the system 10 and the potential for failure, such as via machine learning or other forms of artificial intelligence, as would be readily appreciated.

FIG. 20 depicts one exemplary implementation of the performance model 200 being executed. It is readily appreciated that many approaches are of course possible. In this implementation, the model is begun (box 220) and queries whether there has been a significant change (box 222). If “no,” no further action is taken (box 224A). If yes, the performance model 200 further queries whether the change can be attributed to external factors (box 226), such as those discussed in relation to FIG. 12 and including but not limited to solenoid coil temperature and resistance, cylinder velocity vs. PWM performance, tractor RPM, hydraulic supply pressure, hydraulic oil life monitor, hydraulic oil filter life monitor, tractor hydraulic oil level, and tractor hydraulic flow rate limit settings, among others that would be readily appreciated in the art. If “yes,” no further action is taken (box 224B). If “no,” the operator is alerted (box 228).

Although the disclosure has been described with references to various embodiments, persons skilled in the art will recognize that changes may be made in form and detail without departing from the spirit and scope of this disclosure.

What is claimed is:

1. A sensor for use on an agricultural implement for determining a position of a mechanism, the sensor in communication with an autonomous controller, wherein the autonomous controller verifies position prior to taking an action.

2. The sensor of claim 1, wherein the sensor is a magnetometer and further comprising a magnet disposed on the agricultural implement in proximity to the magnetometer.

3. The sensor of claim 2, wherein the mechanism comprises a cylinder and a rod.

4. The sensor of claim 3, wherein a 3-dimensional reading of the magnetometer is correlated to a stroke of a cylinder.

5. The sensor of claim 4, further comprising a processor in communication with the sensor the processor configured to calibrate the sensor and determine a position of the cylinder based on the calibrated sensor.

6. A non-contact method of determining a position and velocity of a linear actuator on an agricultural implement, comprising:
calibrating at least one sensor in association with the linear actuator;
recording 3-dimentional positions of the at least one sensor during operations; and
determining the position and velocity of the linear actuator from the recorded 3-dimentional position of the at least one sensor.

7. The method of claim 6, wherein the at least one sensor is a magnetometer and magnet.

8. The method of claim 6, further comprising executing one or more operation on the agricultural implement based on the position and velocity of the linear actuator.

9. The method of claim 6, further comprising comparing the position and velocity of more than one linear actuator.

10. An agricultural implement control system, comprising:
(a) at least one position sensor in association with at least one actuator;
(b) a processor in communication with the at least one position sensor configured to determine a position of the at least one actuator,

11. The agricultural implement control system of claim 10, wherein the at least one position sensor comprises a magnetometer and a magnet.

12. The agricultural implement control system of claim 10, further comprising a controller wherein is configured to start and stop an implement operation based on the position of the at least one actuator.

13. The agricultural implement control system of claim 12, wherein the implement operation is autonomous implement folding and unfolding.

14. The agricultural implement control system of claim 12, wherein the implement operation is autonomous implement raising and lowering.

15. The agricultural implement control system of claim 10, wherein the processor is further configured to determine velocity of the at least one actuator.

16. The agricultural implement control system of claim 10, further comprising a feedback position control system configured to define a target position; measure an actual position; calculation a position error from the target position; and command a valve to correct the position error.

17. The agricultural implement control system of claim 16, wherein the feedback position control system is configured to calculate velocity error.

18. The agricultural implement control system of claim 10, wherein the at least one position sensor provides a 3-dimensional reading.

19. The agricultural implement control system of claim 10, further comprising a calibration system configured to calibrate the at least one position sensor to determine if the at least one actuator is operating normally.

20. The agricultural implement control system of claim 10, wherein the at least one position sensor is a non-contact sensor.
